(19) United States
(12) Patent Application Publication
(10) Pub. No.: US 2008/0273110 A1
(43) Pub. Date: Nov. 6, 2008

(54) IMAGE DATA PROCESSING APPARATUS, AND IMAGE DATA PROCESSING METHOD

(76) Inventors: Kazuhiro Joza, Saitama (JP); Chun Zhou, Tokyo (JP); Takeshi Domen, Kanagawa (JP); Masanobu Shibuya, Kanagawa (JP)

Correspondence Address: Pamela R. Crocker;Patent Legal Staff, Eastman Kodak Company, 343 State Street, Rochester, NY, 14650-2201, US

(21) Appl. No.: 11/532,144

(22) Filed: Sep. 15, 2006

(30) Foreign Application Priority Data
Jan. 4, 2006 (JP) 2006-000202

(51) Int. Cl. H04N 5/222

(52) U.S. Cl. 348/333.05; 348/333.01; 348/E05.022

(57) ABSTRACT

An image which has not yet undergone image data processing and an image which has undergone image data processing are displayed so that a difference between the images can be readily recognized. An image obtained by means of a lens and an imaging element is subjected to specific processing, such as correction of red eyes, correction of soft focusing, and the like, in an image processing block. The image processing block displays the image data which have not yet undergone image processing and the image data which have undergone image processing, on an LCD side by side or alternately in time sequence. When a user has operated a joystick, the unprocessed image and the processed image, which are displayed side by side, are concurrently scrolled while maintaining a relationship of a parallel display. A control block synthesizes a message showing specifics image processing and a message showing a processed area with the processed image, and displays the thus-synthesized image on the LC

### CROSS REFERENCE TO RELATED APPLICATIONS

This application claims priority to Japanese Patent Application No. 2006-000202 filed on Jan. 4, 2006, which is incorporated herein by reference in its entirety.

### FIELD OF THE INVENTION

The present invention relates to an image data processing apparatus and an image data processing method, and more particularly, to an apparatus and method for displaying an image which has not yet been processed or an image which has already been processed.

### BACKGROUND OF THE INVENTION

### Related Art

An imaging apparatus, such as a digital camera, having a built-in function of automatically or manually subjecting a photographed image to image processing, has recently come on the market. Such an apparatus is desirably configured so as to display a processing result to the user and determine whether or not the result is to be stored. In order to assist rendering of the determination at that time, the imaging apparatus is desired to be configured so as to be able to display an image which has not yet been processed (hereinafter often called a “unprocessed image”) and an image which has already been processed (hereinafter often called a “processed image”) so as to enable easy comparison of the images.

Japanese Patent Laid-Open Publication No. 2000-125185 describes a technique of effecting autobracket photography operation while changing exposure conditions; arranging sets of image data not in the sequence in which image data have been captured through photographing operation but in the sequence of exposure conditions; and concurrently displaying the sets of image data to thus eliminate a necessity for frame advance operation. The publication also describes a technique for deleting image data other than selected image data with high operability.

Japanese Patent Laid-Open Publication No. 2000-232608 describes that a plurality of sets of image data captured by photographing operation under different exposure conditions are associated with each other as one group. Respective sets of image data associated with the group are automatically displayed on a monitor screen in a switchable manner, one set of image data at a time, by means of a continuous loop mode (a mode of the final set of image data being followed by the first set of image data), thereby avoiding miniaturization of a display of image data, which would otherwise be caused by displaying a plurality of sets of image data, and eliminating a necessity for frame advance operation as well.

It is also conceived that, even when desired sets of image data are selected by means of processing image data after photographing operation, the imaging apparatus is configured so as to display/switch image data in order to ascertain results of processing of the respective sets of image data. At the time of ascertainment of the image data, it is preferable to notify the user of the manner in which the image data have been processed to thereby effectively display processing results.

However, selecting desired sets of data requires comparison of sets of image data. However, the techniques described in the patent publications do not provide sufficient operability for comparison among sets of image data and ascertainment of the results of processing of image data. The technique described in Japanese Patent Laid-Open Publication No. 2000-125185 entails miniaturization of a display, and the technique described in Japanese Patent Laid-Open Publication No. 2000-232608 fails to enable side-by-side comparison of sets of image data. Further, neither Japanese Patent Laid-Open Publication No. 2000-125185 nor Japanese Patent Laid-Open Publication No. 2000-232608 describes a technique of notifying the user of the manner in which image data have been processed to thereby effectively display processing results.

### SUMMARY OF THE INVENTION

Accordingly, the present invention enables easy ascertainment of a difference between images having not yet undergone image processing and images having already been subjected to image processing.

The present invention provides an image data processing apparatus comprising:

a capturing unit for capturing image data;

a processing unit for processing the image data;

a display unit for displaying unprocessed image data and processed image data;

a user operation unit;

a changing unit for changing a display state of the image data displayed on the display unit in accordance with operation of the user operation unit, wherein

the display unit displays the unprocessed image data and the processed image data side by side; and

the changing unit synchronously changes a display state of a remaining set of image data upon changing of a display state of one set of image data of the unprocessed image data and the processed image data, which are displayed side by side.

The present invention also provides an image data processing apparatus comprising:

a capturing unit for capturing image data;

a processing unit for processing the image data; and

a display unit for displaying unprocessed image data and processed image data, wherein

the display unit displays the unprocessed image data and the processed image data side by side; and

the display unit alternately displays the unprocessed image data and the processed image data in time sequence.

In one embodiment of the present invention, changing of the display state corresponds to scrolling; and the changing unit simultaneously scrolls the unprocessed image data and the processed image data in such a way that corresponding portions of the unprocessed image data and the processed image data are displayed on the display unit.

In another embodiment of the present invention, the image data processing apparatus further comprises a synthesizing unit for synthesizing at least any one of specifics data showing specifics of processing of the processing unit area data showing a processed area with at least any one of unprocessed image data and processed image data, and displaying the synthesized image data.

According to the present invention, unprocessed image data and processed image data are displayed side by side or alternately in time sequence. Therefore, the user can readily compare an unprocessed image with a processed image, to thus be able to ascertain the effect of processing. In the present invention, specifics of processing and a processed area are displayed while being synthesized with at least unprocessed image data or processed image data, so that the user can readily ascertain specifics of processing and a processed area.

The invention will be more clearly comprehended by reference to the embodiments provided below. However, the scope of the invention is not limited to these embodiments.

### BRIEF DESCRIPTION OF THE DRAWINGS

Preferred embodiments of the present invention will be described in detail based on the following figures, wherein:

FIG. 1 is a block diagram showing the entire configuration of a digital camera of an embodiment of the present invention;

FIG. 2 is a flowchart of overall processing of the embodiment;

FIG. 3 is a flowchart of interrupt processing of the embodiment;

FIG. 4 is a flowchart of processing in a photographing mode;

FIG. 5 is a flowchart of processing in a browsing mode;

FIG. 6 is a flowchart of processing in a setting mode;

FIG. 7 is a detailed flowchart of processing in the photographing mode;

FIG. 8 is a detailed flowchart of face recognition processing;

FIG. 9 is a descriptive view showing an example screen used for confirming face processing;

FIG. 10 is a descriptive view showing an example screen used for selecting a face processing method;

FIG. 11 is a detailed flowchart of a parallel display mode;

FIG. 12A is a descriptive view showing an example screen acquired before being scrolled;

FIG. 12B is a descriptive view showing an example screen acquired after having been scrolled;

FIG. 13A is a descriptive view showing image data before being processed;

FIG. 13B is a descriptive view showing an example screen acquired after enlargement;

FIG. 14A is a descriptive view showing image data before being processed;

FIG. 14B is a descriptive view showing an example screen acquired after rotation;

FIG. 15 is a detailed flowchart of a toggle mode;

FIG. 16A is a descriptive view showing an example screen of processed image data;

FIG. 16B is a descriptive view showing an example screen of image data acquired before being processed;

FIG. 17 is a detailed flowchart of a routine for retaining image data;

FIG. 18 is a detailed flowchart of a routine for selecting any one from retained images;

FIG. 19A is a descriptive view showing an example selection screen;

FIG. 19B is a descriptive view showing an example screen used for selecting an additional image processing method; and

FIG. 20 is a flowchart of processing of interim storage of an image (an image scheduled to be deleted).

### DETAILED DESCRIPTION OF THE INVENTION

An embodiment of the present invention will be described hereinbelow by reference to the drawings.

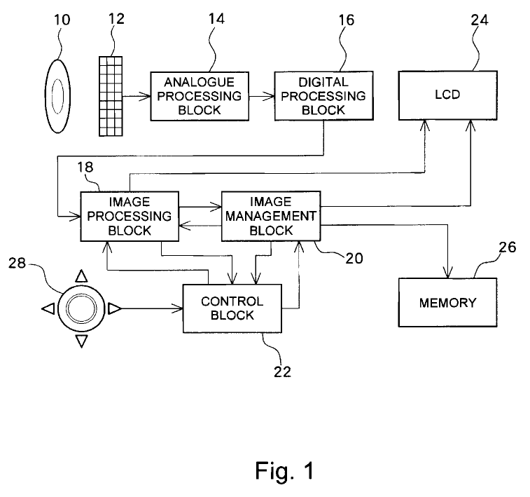

FIG. 1 is a block diagram showing the entire configuration of a digital camera of an embodiment of the present invention. Optical information about a field is converted into an electrical signal by means of a lens 10 and an imaging element 12. The electrical signal is subsequently converted into image data by way of an analogue processing block 14 and a digital processing block 16, and the image data are supplied to an image processing block 18.

The image processing block 18 automatically processes the image data supplied from the digital processing block 16, and a processed image (a processed image) and an image having not yet been processed (an unprocessed image) are delivered to an image management block 20. The image processing block 18 automatically detects the range of a face portion, red eyes, an area which would cause a change greater than a threshold value before and after correction, and the like in the supplied image; and displays the detected range in an enlarged manner. Upon receipt of the designation of a range, such as the designation of a user range, designation of a user's face, and the like, from a control block 22, the image processing block 18 processes an image in the range. After the image has been processed, an unprocessed image and a processed image are displayed on display means, such as an LCD 24 and the like, in a predetermined pattern such as a parallel scroll. The designation of a display range of a pre-processing/processed image, a toggle method, or automatic switching among images can also be adopted as the display pattern.

The image management block 20 imparts date data to the image data supplied from the image processing block 18, and further imparts a “retain” flag to an image designated to be retained or an “interim storage” flag to an image designated to be unretained. The image management block 20 monitors a period of storage in memory 26 of an image imparted with “interim storage” flag. Further, the image whose predetermined period of storage has expired is displayed on the LCD 24 at startup of the camera, thereby prompting the user to delete or save the image.

The control block 22 detects user's operations such as operation of a joystick 28 and the like, and controls respective blocks. Example operations of the user include the designation of a user range, the designation of a user's face, selection of an image to be stored by the user, and the like. An image to be retained (an image set so as to be automatically retained or an image selected by the user) is marked with the designation of retainment.

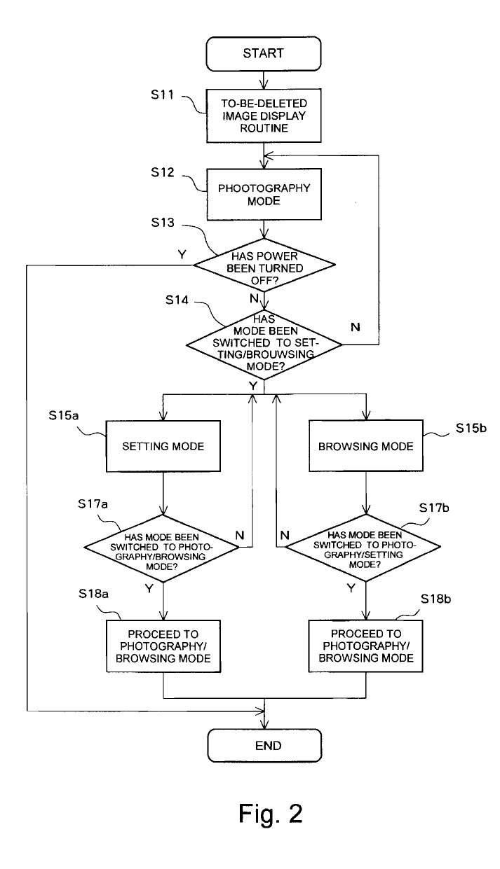

FIG. 2 is a flowchart of overall processing of the digital camera of the present embodiment. First, a routine for displaying an image scheduled to be deleted (S11) is performed. This processing is for displaying, on the LCD 24, image data for which a given period of time has elapsed from the shooting date, from among sets of image data to be unretained which have already been photographed and stored in memory and not been selected by the user and have remained in interim storage, thereby inquiring of the user whether or not to delete the image data. By means of this processing, unwanted image data are deleted to thus ensure the capacity of the memory. Processing proceeds to a photographing mode (S12). In the photographing mode, the image data acquired by means of the lens 10 and the imaging element 12 are processed, and the thus-processed image data are displayed on the LCD 24. The image data are stored in memory by means of the user actuating a release button. When the power switch has been turned off in the photographing mode, processing ends (S13); otherwise, a determination is made as to whether or not the user has operated a mode setting button to thus have switched the mode from the photographing mode to the setting mode or a browsing mode (S14).

When the user has effected switching to the setting mode (S15a), there is carried out setting of a default display mode and a determination as to whether or not image data having undergone image processing are automatically retained, setting of a period during which an image to be unretained is held in interim storage and a threshold value for an enlarged display, or the like. A determination is made as to whether or not the user has operated the mode setting button in the setting mode to thus have terminated the setting mode and effected switching to the photographing mode or the browsing mode (S17a). When the user has switched the mode, processing proceeds to the thus-selected mode (S18a). When either one of the unprocessed image and the processed image has already been deleted, a remaining image is displayed.

When the user has effected switching to the browsing mode (S15b), the image data having undergone image processing and the image data having not yet undergone image processing are displayed in the set display mode. For instance, an unprocessed image and a processed image are displayed side by side, in an alternating manner, or the like. Processing pertaining to steps S17b, S18b is analogous to processing pertaining to steps S17a, S18a.

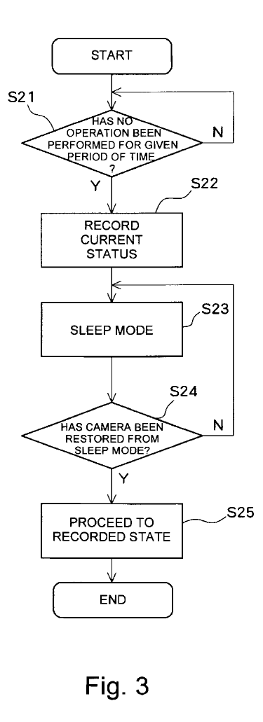

FIG. 3 shows a sleep shift routine to be processed in the middle of activation of power, by means of interrupt processing. When no operation is determined to have been performed for a given period of time (S21), a current status is recorded (S22), only a specific function block is brought into an operating state, and the imaging apparatus enters a sleep mode where power consumption is reduced (S23). When the imaging apparatus has restored itself from the sleep mode in response to any operation performed by the user (S24), the imaging apparatus enters the state where the current state has been recorded in S22 (S25).

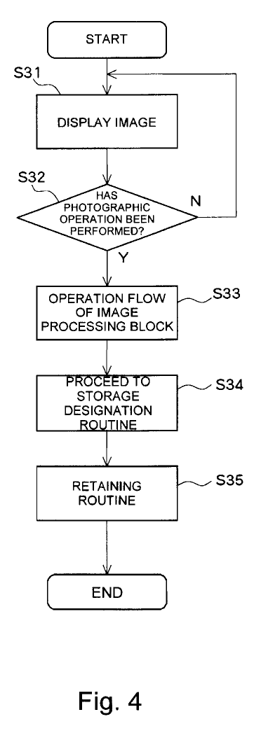

FIG. 4 shows a flowchart of the photographing mode pertaining to S12. The image data captured by means of the lens 10 and the imaging element 12 are displayed on the LCD 24 (S31). When photographing operation has been performed; namely, when the release button has been operated (S32), the image processing block 18 executes predetermined image processing (S33), and processing proceeds to a specified routine for determining whether or not a photographed image is retained (S34). By means of the retainment designation routine, either one of the unprocessed image and the processed image is designated to be retained. The imaging apparatus may also be configured so as to further perform specific image processing when an image is retained. When an image to be retained has been designated, a routine for retaining the image is executed (S35).

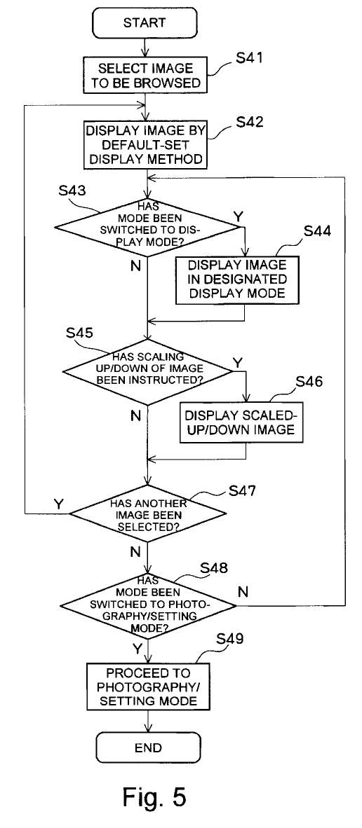

FIG. 5 shows a flowchart of a browsing mode pertaining to S15b. First, image data which the user desires to browse are selected from among the sets of image data stored in the memory 26 (S41). When the image has been selected, the control block 22 displays the selected image data on the LCD 24 by means of a default display method (S42). The default display method is for displaying, e.g., an unprocessed image and a processed image, side by side. When the user has switched the display mode in this state (S43), the image data are displayed in the designated display mode (S44). Switching of the display mode is switching of the parallel display mode to a mode of alternately displaying an image having not yet undergone image processing and an image having undergone image processing, or the like, by means of operation of buttons. When the user has instructed scale-up or scale-down (S45), a display image is displayed in a scaled-up or scaled-down manner (S46). When the user has selected another set of image data (S47), the thus-selected other image is again displayed by the default display method (S42). When the user has switched to the photographing mode or the setting mode (S48), the browsing mode is terminated, and processing proceeds to either the photographing mode or the setting mode (S49). Example methods for displaying image data are as follows:

(1) Parallel Display Mode

A mode for displaying side by side an image having not yet undergone image processing and an image having undergone image processing. In response to a scroll operation by the user, the unprocessed image and the processed image, which are displayed side by side, are simultaneously scrolled.

(2) Pre-processing/processed image display mode

A mode for displaying an unprocessed image and a processed image on a monitory by means of the user designating a range. In contrast with designation of a range during image processing, which will be described later, image processing is not performed after designation of the range. This mode is for displaying the unprocessed image and the processed image so as to facilitate comparison therebetween.

(3) Toggle Mode

A mode for switching the unprocessed image to the processed image by means of a button.

(4) Automatic Switching Mode

A mode in which the unprocessed image is switched to the processed image after elapse of a given period of time.

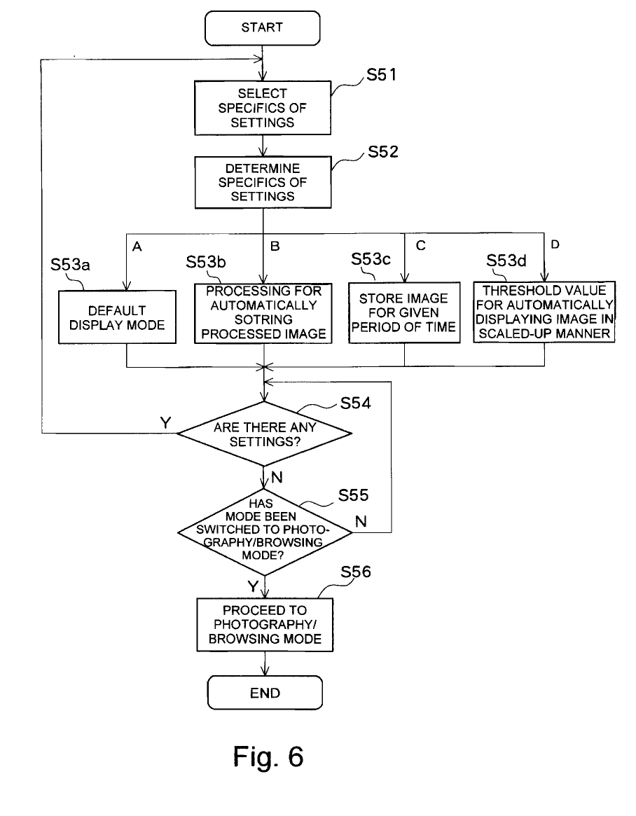

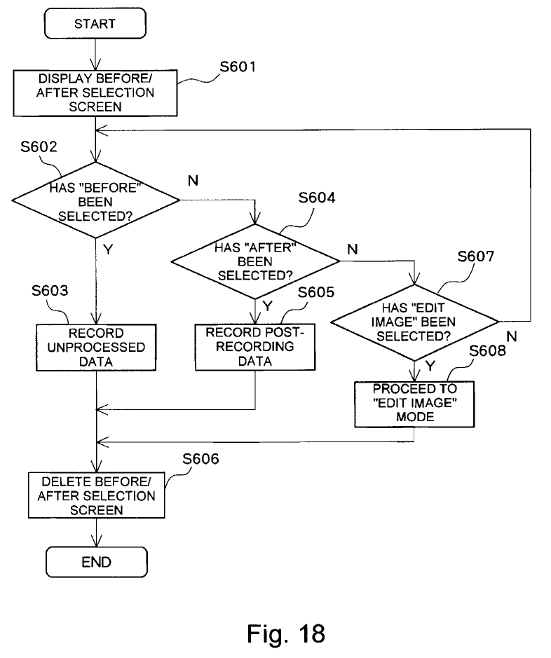

FIG. 6 shows the flowchart of a setting mode pertaining to step S15a. First, the user selects specifics of settings from the menu screen appearing on the LCD 24 (S51). Specifics of the settings include (A) a default display method; (B) processing for automatically retaining a processed image; (C) a period during which an image designated to be unretained is held in interim storage; and (D) setting of a threshold value used for effecting an automatic enlarged display, and the like. The control block 22 determines which one of the specifics of the settings has been selected by the user (S52). Any one of (1) to (4) is selected as the default display mode (S53a). Correction of red eyes, backlighting compensation, and the like, are mentioned as processing for automatically retaining a processed image (S53b). Although settings are effected so as to automatically retain a processed image, the settings may also be effected so as to enable the user to select between automatic retainment and manual retainment. When manual retainment has been selected, the routine shown in FIG. 18 is executed. Every time the user is inquired about retaining which one of an unprocessed image and a processed image, as the occasion arises, thereby setting an image to be retained.

For instance, a week, ten days, and the like, are set as a period for interim storage (S53c). Numerals used for setting a threshold value for enlarged display include brightness, saturation, a hue, and the like (S53d). Next, a determination is made as to whether or not there are other settings (S54). After all settings have been completed, processing proceeds to the photographing mode or the browsing mode (S55, S56).

Respective processing operations will be described in detail hereunder.

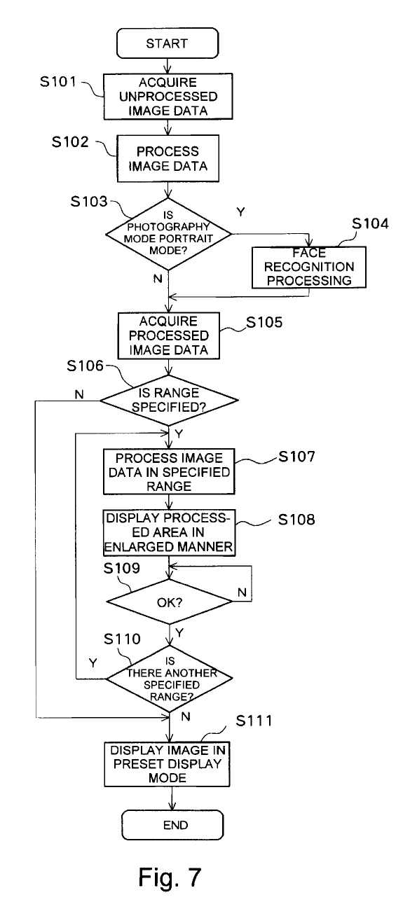

FIG. 7 shows a detailed flowchart of the photographing mode. Image data, which have not yet undergone image processing, are acquired by the lens 10 and the imaging element 12 (S101). The image data are subjected to basic image processing, such as white balance, brightness, sharpness, and the like (S102). A determination is made as to whether or not the photographing mode is a portrait mode (S103). The reason why a determination is made as to whether or not the photographing mode is a portrait mode is because a determination is made as to whether or not image processing unique to a person must be performed. When the photographing mode is a portrait mode, predetermined face recognition processing is performed (S104). During face recognition processing, a face portion of the subject is extracted, and the thus-extracted face portion is subjected to other correction processing such as correction of red eyes, thereby acquiring a processed image (S105). In the present embodiment, the term “processed image” includes unique processing complying with the photographing mode, and the like, such as white balance processing, brightness processing, sharpness processing, and the like. The processed images may also be defined as only images having undergone unique processing. After acquisition of the processed image, a determination is made as to whether or not the designation of a range has been performed during image processing (S106). The designation of a range performed during image processing includes a range where a difference between an unprocessed image and a processed image has exceeded a threshold value (automatically detected by the camera), the range of a face portion (automatically designated by the camera or designated by the user), and a user designation range (designated by the user). When a range has been designated during image processing, a face portion, e.g., is processed (S107), and the thus-processed portion is displayed in an enlarged manner (S108). A determination is made as to whether or not the processed portion is acceptable (S109). When the user has made an affirmative answer by means of operating an OK button displayed on the LCD 24 or the like, another determination is made as to whether or not there is another range has been designated (S10). When processing of all the designated ranges has been completed, the processed image is displayed in a set display mode (S11). When there is no designation of a range, a processed image is immediately displayed (S11). When the default display mode is a parallel display mode, the image acquired in S101 and the image processed in S105 or S107 are displayed side by side.

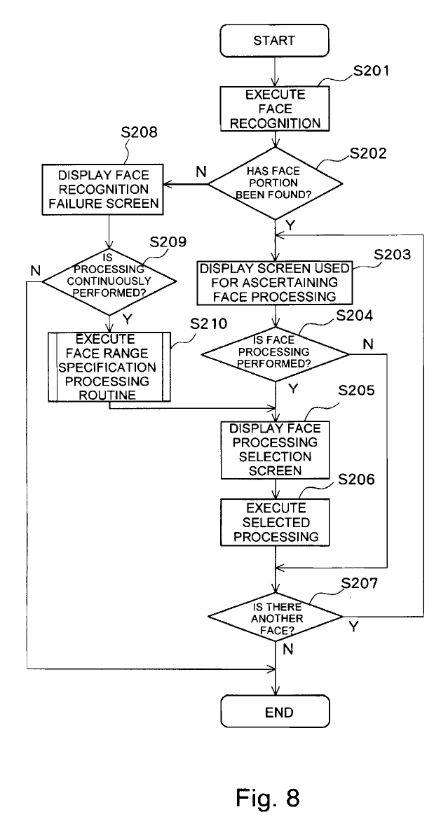

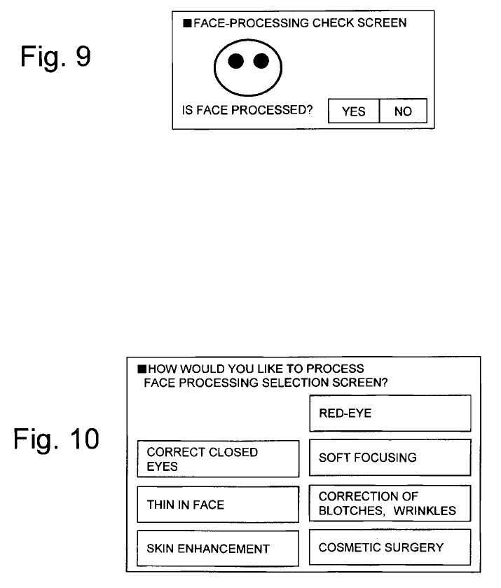

FIG. 8 shows a detailed flowchart of face recognition processing pertaining to S104. In the portrait mode or the like, predetermined face recognition processing is first performed (S201). Face recognition processing is known. For instance, a face portion of the subject is recognized by means of recognizing a skin color, or extracting characteristic features of the face portion such as eyebrows, eyes, a nose, lips, and the like. When the face portion cannot be found in the subject (NO in S202), a message indicating a failure to recognize a face is displayed on the LCD 24 (S208), thereby determining whether or not to continue processing (S209). When the user has input a command indicating continuance of processing, a face range designation processing routine is executed (S210). By means of the face range designation processing routine, an unprocessed image is displayed, and the user is caused to enter a range to be processed. The range is designated by a rectangular or a free-form curve. For instance, the user designates a face portion, which is present in the subject, as a rectangular area. Subsequently, the camera again performs face recognition on the premise that a face is present in the area designated by the user as the face portion. Meanwhile, when the face portion has been found, a face processing confirmation screen is displayed (S203). FIG. 9 shows an example face processing confirmation screen. An icon corresponding to the face portion or the confirmed face portion itself is displayed while being clipped. Further, a “YES” button and a “NO” button are displayed at predetermined positions in the screen. When the user has selected the “YES” button, processing proceeds to face processing (S204). During face processing, a screen used for selecting a face processing method is first displayed (S205). FIG. 10 shows an example face processing selection screen. Correction of red eyes, correction of closed eyes, soft focusing, making a face thin, concealing blotches and wrinkles with makeup, skin enhancement, cosmetic surgery, and the like, are displayed as a method for processing a face. Correction of closed eyes is processing for clipping eyes from another image with open eyes and replacing closed eyes of the subject with the thus-clipped open eyes. Making a face thin is processing for changing an aspect ratio of a face image. Concealing blotches and wrinkles is processing for eliminating blotches and wrinkles from the face image. Skin enhancement is processing for whitening a skin color of the face image. Cosmetic surgery is processing for enhancing the contour of the eyes. When the user has selected any one or some of these methods by use of the joystick 28, the image processing block 18 performs processing selected in accordance with a command from the control block (S206). When all of the faces are subjected to the above processing operations (S207), whereby processing is completed.

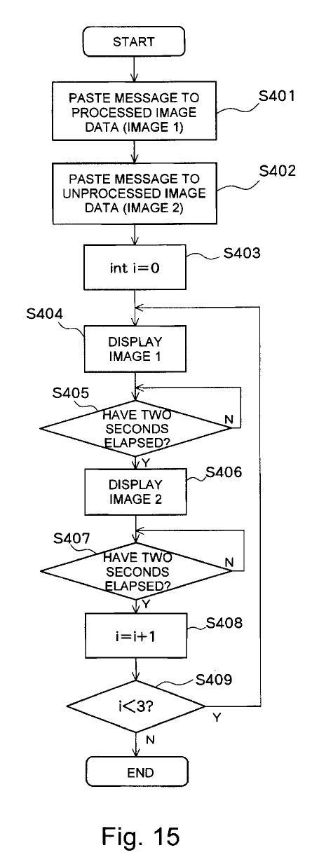

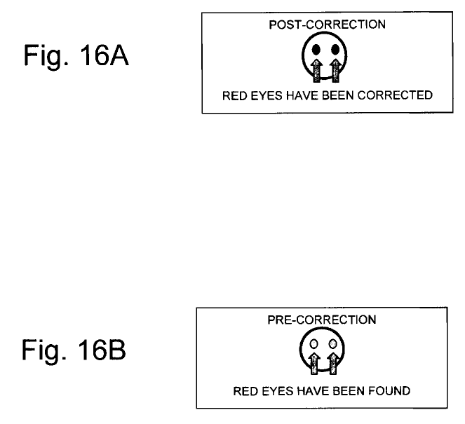

FIG. 15 is an example flowchart of a method for notifying the user of red eyes having been corrected. After acquisition of image data having not yet undergone image processing and image data having undergone image processing, a predetermined message is pasted to the image data having undergone image processing (S401). A predetermined message shows details of processing or locations to be processed. For instance, when red eyes have been corrected, details of processing are “Red eyes have been corrected” or the like. FIG. 16A shows an example screen into which the message is pasted to the image data having undergone image processing. When red eyes have been corrected, a message of “Corrected” is pasted to a location above the face image, and another message of “Red eyes have been corrected” is pasted to a location below the face image. Further, arrows indicating processed areas are displayed in a pasted manner. Next, a predetermined message is pasted in the same manner to the image data having not yet undergone image processing (S402). FIG. 16B shows an example screen into which a message is pasted to the image data having not yet undergone image processing. An arrow is displayed in an overlapped manner at an area to be subjected to face processing; i.e., red eyes. Namely, a message of “To be corrected” is displayed in a pasted manner at a position above the face, and a message of “Red eyes have been found” is pasted to a position below the face image. After the messages have been pasted to the respective sets of image data, a counter “i” is reset to zero (S403). First, an image 1 is displayed (S404). The “image 1” signifies (BEFORE) image data having not yet undergone image processing. When the image 1 has been displayed for a given period of time; for instance, when two seconds have elapsed (S405), an image 2 is displayed in place of the image 1 (S406). The “image 2” signifies (AFTER) image data having undergone image processing. After a given period of time; e.g., two seconds, has again elapsed since display of the image 2 (S407), the counter “i” is incremented by one (S408). A determination is made as to whether or not the counter “i” has reached three (S409). When the count value of the counter “i” is smaller than three, processing subsequent to step S404 is iterated. When the counter “i” has reached three; namely, when alternate display of the image 1 and the image 2 has been repeated three times, processing ends. Switching of the image 1 to the image 2 may be realized by means of wipe processing (processing for closing the curtain for the image 1 and opening the curtain for the image 2) or dissolve processing (the resolution of the image 1 is gradually decreased whilst the resolution of the image 2 is gradually increased, and the image 1 is finally replaced with the image 2), in addition to mere switching of a display from the image 1 to the image 2. When the image 2 is displayed, an area to be processed (corrected) or details of processing (correction) may be highlighted or blinked. For instance, in FIG. 16A, an arrow is displayed in a blinking manner, or a message of “Red eyes have been corrected” is displayed in a blinking manner. As a result of alternate switching between the screen 1 and the screen 2, the user can readily confirm the changes achieved before and after image processing, and can readily ascertain the processed areas and details of processing. Thus, displaying details of processing and processed areas is suitable particularly for a case where the digital camera automatically performs image processing. The user is uncertain about specifics of processing and processed areas. It is assumed that the user encounters difficulty in ascertaining the effect of image processing. As a result of the image shown in FIG. 16A and the image shown in FIG. 16B being alternately displayed in time sequence, the user can readily confirm that the red eyes of the subject have been corrected.

When specifics of processing correspond to face recognition and face processing associated therewith, an arrow indicating a face portion is displayed in conjunction with a message of “The face is recognized.” Alternatively, an arrow indicating an eye section is displayed in conjunction with a message of “Closed eyes have been corrected.”

In a case where specifics of processing and a processed area are displayed while being pasted to (AFTER) image data having undergone image processing, the specifics of processing and the processed area may be displayed in a synthesized manner only when a comparison between the (AFTER) image data having undergone image processing and (BEFORE) image data having not yet undergone image processing shows that a difference is a predetermined threshold value or more. For instance, in the case of correction of red eyes, a predetermined message is not synthesized when the colors of the eye sections acquired after correction of red eyes are essentially the same as the colors of the eye sections which have not yet been corrected. Moreover, the (BEFORE) unprocessed image data and (AFTER) processed image data may be compared with each other; an area which exhibits the largest difference may be taken as a processed area; and specifics of processing may be displayed in a synthesized manner. For instance, even when correction of red eyes and skin enhancement correction have been simultaneously performed, an arrow indicating an eye section is displayed along with a message of “Red eyes have been corrected,” and the like, only when a difference resulting from correction of red eyes is a maximum. Alternatively, even when skin enhancement correction has been carried out, an arrow is displayed at the position of a nose section in a case where a difference stemming from the nose section is a maximum. As a result, complication of an image, which would otherwise be caused by displaying many messages on the small LCD 24, can be prevented. The user can ascertain specifics of processing and a processed area at a glance. Alternatively, a message showing specifics of processing may be displayed while being pasted to an unprocessed image or while being pasted to both an unprocessed image and a processed image. Alternatively, the imaging apparatus may also be configured so that the user can set which one of the images is displayed while being synthesized with a message.

In the processing described in FIG. 15, the screen 1 and the screen 2 are displayed while being automatically switched at a given time cycle. However, the screen 1 and the screen 2 may be displayed in a switchable manner by means of operation of buttons performed by the user. In this case, steps S406 and S408 correspond to processing for determining whether or not the user has operated a changeover button.

By means of rendering a determination, in S209, as to whether or not there is another face, all of the faces existing in the subject are subjected to face processing. However, the face of only the specific person may be specified by the user and subjected to processing.

A method analogous to this embodiment can also be used for notifying the user of image processing other than face processing having been performed. Further, when a difference between the unprocessed image and the processed image is equal to a threshold value or more, the specifics of processing are reported, and the area exhibiting the maximum difference is displayed. This method can also be applied to image processing other than face processing.

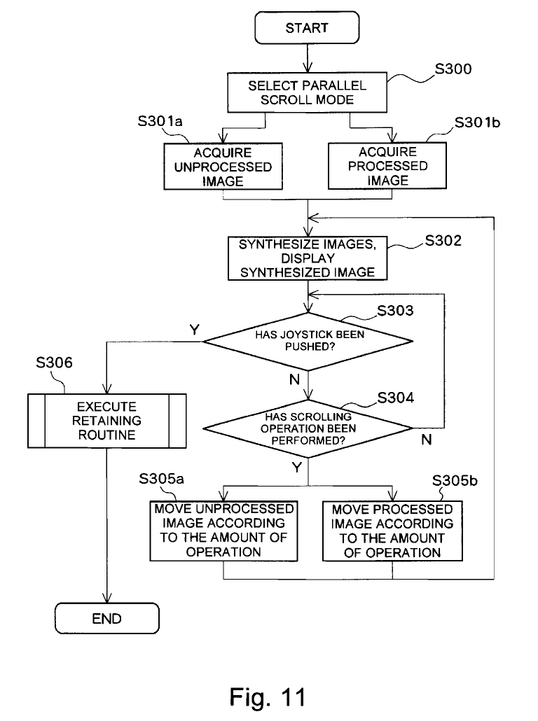

FIG. 11 shows a flowchart employed when a parallel display mode (a parallel scroll mode) is set as a display mode; for instance, a case where a parallel display mode is set as a default display mode in S52a in FIG. 6 (S300). This flowchart naturally includes a case where switching has been effected from another display mode to the parallel display mode in S43 shown in FIG. 5. In this mode, the (BEFORE) image data having not yet undergone image processing and the (AFTER) image data having undergone image processing are captured in this mode (S301a, S301b), and the sets of image data are displayed on the LCD 24 while being synthesized in such a way that the two sets of image data are arranged side by side (S302).

FIG. 12A shows an example screen on which the (BEFORE) image data having not yet undergone image processing and the (AFTER) image data having undergone image processing are displayed side by side. The image data having not yet undergone image processing are displayed on the left side of the drawing, and the image data having undergone image processing are displayed on the right side of the same. In order to enable the user to readily, visibly recognize the processed image data, labels; i.e., BEFORE, AFTER, and the like, may also be displayed while being superposed on the respective sets of image data.

After the images have been displayed in a synthesized manner, a determination is made as to whether or not the user has operated the joystick 28 (S303). When the user has performed scrolling by operation of the joystick 28 (S304), the image processing block 18 moves, in the operating direction, the (BEFORE) image data having not yet undergone image processing in accordance with the amount of operation, and displays the thus-moved image data. In association with the change in display state, the (AFTER) image data having undergone image processing are also concurrently shifted in the same direction over the same distance, and the thus-moved image data are displayed (S305a, S305b).

FIG. 12B shows an example screen appearing during scrolling operation. Both the (BEFORE) image data having not yet undergone image processing and the (AFTER) image data having undergone image processing are moved in the same direction and over the same distance, and are displayed while a parallel relationship between the two sets of image data is maintained. Accordingly, the user can always compare corresponding areas in both sets of image data with each other at a glance. Since the (BEFORE) image data having not yet undergone image processing and the (AFTER) image data having undergone image processing are scrolled synchronously, the user can save the labor of, after having scrolled either one of the sets of image data, scrolling the other set of image data. FIG. 12B shows a case where the user operates the joystick 28 upward, to thus effect an upward scroll. However, the same also applies to a case where a downward scroll is effected and a case where a sideways scroll is effected. In the browsing mode, scale-up or scale-down processing as well as scrolling are feasible as shown in FIG. 5 (S45, S46). When scale-up or scale-down is input by the user, the image processing block 18 displays the (BEFORE) image data having not yet undergone image processing in a scaled-up or scaled-down manner. In synchronism with the scale-up or scale-down, the corresponding area of the (AFTER) image data having undergone image processing is also simultaneously displayed in a scaled-up or scaled-down manner.

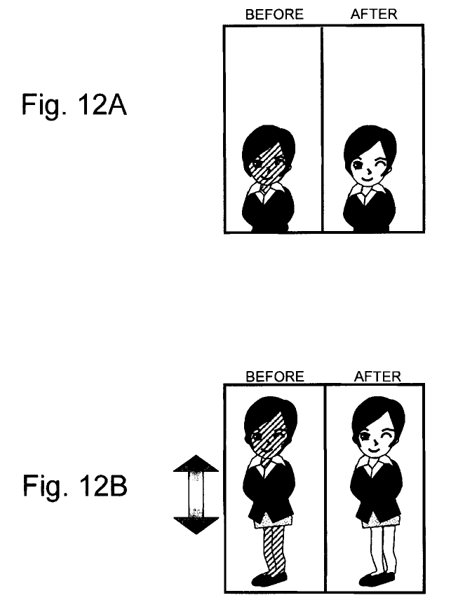

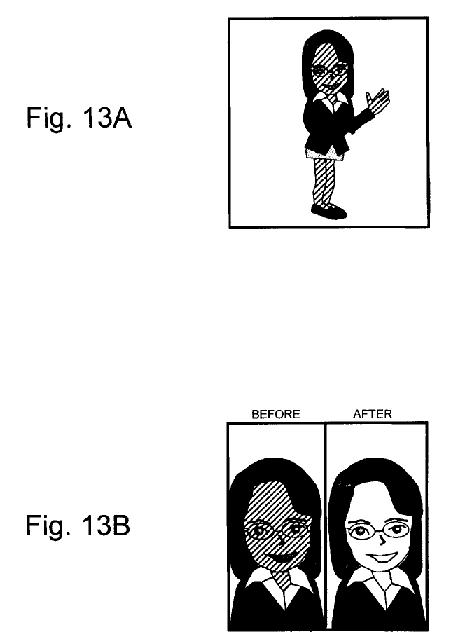

FIGS. 13A and 13B show example screens acquired at the time of a scaled-up display. FIG. 13A shows an example display of image data having not yet been enlarged (unscaled image data) [(BEFORE) image data having not yet undergone image processing]. FIG. 13B shows an example parallel display of scaled-up image data. When the (BEFORE) image data having not yet undergone image processing are scaled-up, the counterpart area of the (AFTER) image data having undergone image processing is also synchronously scaled-up by the same magnifying power. Moreover, in the browsing mode, the image data can also be rotated.

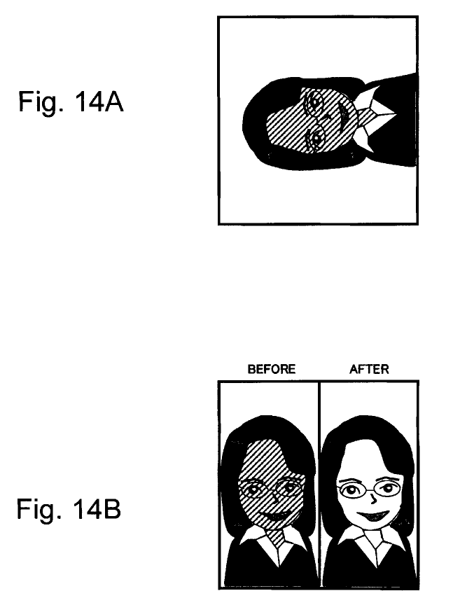

FIGS. 14A and 14B show example screens acquired when images are displayed in a rotating manner. FIG. 14A shows (BEFORE) image data having not yet undergone image processing captured when photographing has been performed with the orientation of the digital camera being changed (from a landscape orientation to a portrait orientation). FIG. 14B shows an example parallel display acquired when the orientation of the subject has been rotated through 90 degrees. The (BEFORE) image data having not yet undergone image processing and the (AFTER) image data having undergone image processing are displayed side by side after having been rotated in the same direction through the same rotational angle. When the user has further depressed the rotation button, both sets of image data are displayed side by side after having been simultaneously rotated in accordance with the amount of operation. The user can change the orientations of the sets of image data to a desired direction by a single operation, thereby facilitating a comparison between the sets of image data. Meanwhile, when the user has pressed the joystick 28, the image management block 20 executes a retainment routine in response to a command from the control block 20 (S306).

As mentioned previously, in addition to the parallel display mode, there can also be adopted a display mode of designating a display range of an unprocessed/processed image, a toggle display mode, or a display mode for automatically switching a display.

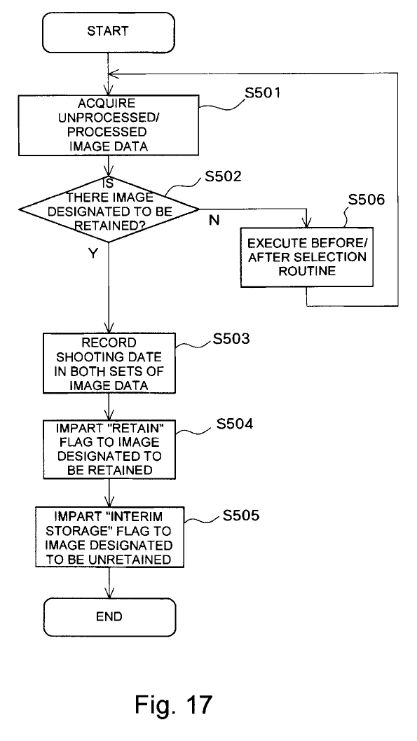

FIG. 17 shows a flowchart of a retainment routine. When unprocessed image data and processed image data have been captured and when the user has pressed the joystick 28 (see S303, S306), the control block 22 determines whether or not there is an image designated to be retained (S502). This image designated to be retained is set in S52b; and includes a processed image for which settings for retaining a process image are set, an image for which a retainment operation has been performed by means of a toggle display while being displayed; and an image for which a retainment operation has been performed by means of a routine for displaying an image scheduled to be deleted. When the image designated to be retained is not present, a predetermined selection routine is executed (S506). When the image designated to be retained is present and when settings have been effected to retain processed images in all processing operations, the image management block 20 records both unprocessed image data and processed image data while adding shooting date data to these sets of image data, in response to a command from the control block 22 (S503). Further, a retainment flag is imparted to an image designated to be retained (processed image data in this case) (S504). An interim storage flag is imparted to an unretained image (unprocessed image data in this case) (S505). The reason why the unretained image data are temporarily stored without being immediately deleted is because consideration is given to a case where the user may require unprocessed image data after the processed image data have been automatically retained in the memory 26.

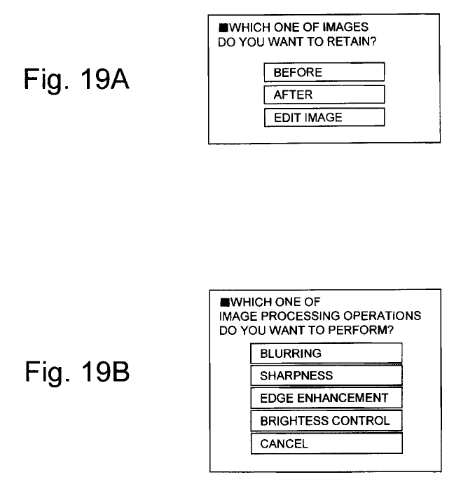

FIG. 18 shows a flowchart of a selection routine in S506. This routine corresponds to processing for the user selecting either one from the (BEFORE) image data having not yet undergone image processing and the (AFTER) image data having undergone image processing, as the occasion arises. The control block 22 displays on the LCD 24 an image used for selecting either the BEFORE image or the AFTER image as an image to be retained (S601). FIG. 19A shows an example selection screen. When the user desires to retain unprocessed image data, the user presses the “BEFORE” button. In contrast, when the user desires to retain processed image data, the user presses the “AFTER” button. An “EDIT IMAGE” button is to be operated when a selected image is to be subjected to further processing. When the “BEFORE” button has been selected (S602), the image management block 22 stores unprocessed image data into the memory 26 (S603). Meanwhile, when the “AFTER” button has been selected (S604), the image management block 22 stores processed image data into the memory 26 (S605). Then, the selection screen is deleted (S606). When the user has selectively operated the “EDIT IMAGE” button (S607), the control block 22 executes a predetermined processing mode without retaining the unprocessed image data or the processed image data into the memory 26 (S608). In this mode, subjecting either the unprocessed image data or the processed image data to additional processing can be selected. For instance, a selection screen such as that shown in FIG. 19B is displayed on the LCD 24, and any one of processing operations of blurring, sharpness control, edge enhancement, and brightness control is performed. As a result, the request of the user who cannot satisfy the automatically-processed image data can be fulfilled. The EDIT IMAGE routine can be invoked from the browsing mode as well as from the photographing mode. After completion of the EDIT IMAGE routine, a retainment flag is imparted to the image that has become an object to be edited by the user. An interim storage flag is imparted to the image which has not become an object of edition.

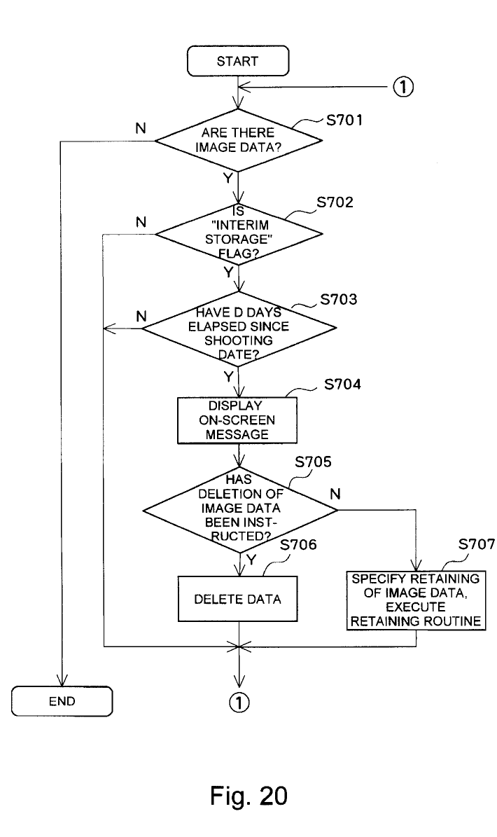

FIG. 20 shows a flowchart for processing the image data imparted with the interim storage flag in S505. Processing is to be executed as “a routine for displaying an image scheduled to be deleted” in S11. The image data imparted with the interim storage flag are intrinsically considered to be unnecessary, and hence correspond to image data scheduled to be deleted. The image management block 20 determines whether or not the image data stored in the memory 26 are present (S701). When the image data are present, another determination is made as to whether or not the image data are imparted with the interim storage flag (S702). When the image data are imparted with the interim storage flag, a determination is made as to whether or not a predetermined period D of time (e.g., ten days) has elapsed from the shooting date, in connection with the unprocessed image data in a case where settings are effected such that processed image data are to be retained (S703). This period may be fixed or can be set by the user. When the user sets the period, settings are made in S52c. When the predetermined period has elapsed, the image data are displayed on the LCD 24, and there is displayed a screen for inquiring the user of whether or not to delete the image (S704). When the user has selected deletion (S705), the image management block 20 deletes the image data (S706). Meanwhile, when the user has not selected deletion, a retainment flag is imparted in place of the interim storage flag to the image data, and the image data are stored in the memory 206 (S707). All of the sets of image data stored in the memory 26 are subjected to the above-described processing operations. Thereby, among the sets of image data imparted with the interim storage flag, the image data desired by the user are not deleted and are retained in the memory 26.

Although the present embodiment has been described above, the present invention is not limited to the embodiment and can assume various modes.

For instance, according to the face range designation processing routine pertaining to S212 in FIG. 8, the user operates the joystick 28 to thus designate the center position of the face portion of the subject. Subsequently, the user operates the joystick 28 vertically or horizontally to thus change the size of an oval shape imitating the contour of the face in an incrementing or decrementing manner, whereby a face range can be designated. An arbitrary range other than the face can also be designated in a similar manner; namely, designation of a left half, a right half, an upper half, and a lower half of the subject. Moreover, designation of the face includes designating as a range a polygonal area, a free-form curve, or a circular area of arbitrary radius. The range may also be formed as a concentric circle. The center position of the circular area may be arbitrarily altered.

The present embodiment has described the example of a digital camera. However, the present invention is not limited to the digital camera, and can be applied to all types of equipment, computers, and programs having the function of comparing a plurality of sets of similar image data with each other and displaying the image data, such as image processing software or the like. Examples of analogous image data include image data captured by means of bracket-photographing a single subject, and the like. When the present invention is applied to a computer, the image processing block 18, the image management block 20, and the control block 22, all of which are shown in FIG. 1, are formed into an MPU of the computer. The MPU inputs a photographed image; subjects the image to predetermined image processing; and displays on display means unprocessed image data and processed image data, side by side or alternately in time sequence. When the user operates a keyboard or a mouse, during parallel display, to thus scroll an image, the MPU simultaneously scrolls the unprocessed image data and the processed image data. Moreover, when the processed image has been subjected to automatic image processing, the MPU displays on the display means specifics of processing and a processed area superposed to the processed image data, thereby notifying the user of image processing.

In the present embodiment, an arbitrary range of an unprocessed image and an arbitrary range of a processed image can be displayed in the unprocessed/processed image display mode. The display ranges can also be arbitrarily altered by means of the user operating the joystick 28. In the parallel display mode shown in FIG. 13B, images are displayed side by side. The user can horizontally shift a boundary of the display region by means of operating the joystick 28, thereby scaling down one display region and scaling up the remaining display region. In this case, the size of the unprocessed image and the size of the processed image may be maintained intact. Alternatively, the sizes of the images may also be scaled up or down in accordance with a scale-up or scale-down of the display state. In the latter case, the display range of the processed image is scaled up, and the size of the unprocessed image is scaled down in accordance with the scaled-down display state.

Although the present embodiment has stated an example where the camera performs automatic processing after photographing operation, the present invention can also be applied to a case where the user manually performs image processing without the camera performing automatic processing, compares a result of image processing achieved before processing with a result of image processing achieved after processing, and scales up an area which has changed, or to a like case.

### PARTS LIST

10 lens
12 imaging element
14 analogue processing block
16 digital processing block
18 image processing block
20 image management block
22 control block
24 LCD
26 memory
28 joystick
S11 to be deleted image display routine
S12 photography mode
S13 has power been turned off
S14 has mode been switched to setting/browsing mode
S15a setting mode
S15b browsing mode
S17a has mode been switched to photography/browsing mode
S17b has mode been switched to photography/setting mode
S18a proceed to photography/browsing mode
S18b proceed to photography/browsing mode
S21 has no operation been performed for a period of time
S22 record current status
S23 sleep mode
S24 has camera been restored from sleep mode
S25 proceed to recorded state
S31 display image
S32 has photographic operation been performed
S33 operation flow of image processing block
S34 proceed to storage designation routine
S35 retaining routine
S41 select image to be browsed display image by default-set display method
S43 has mode been switched to display mode
S44 display image in designated display mode
S45 scale-up or scale down instructions
S46 image displayed in scale-up/down image
S47 select another set of image data
S48 has mode been set to photography/setting mode
S49 proceed to photography/setting mode
S51 select specifics of settings
S52 determine specifics of settings
S53a default display mode
S53b processing for automatically sorting processed image
S53c store image for given period of time
S53d threshold value for automatically displaying image in scaled-up manner
S54 any other settings needed
S55 has mode been switched to photography/browsing mode
S56 proceed to photography/browsing mode
S101 acquire unprocessed image data
S102 process image data
S103 is photography mode portrait mode
S104 face recognition processing
S105 acquire processed image data
S106 is range specified
S107 process image data in specified range
S108 display processed area in enlarged manner
S109 is processed portion acceptable
S110 is there another specified range
S111 display image in preset display mode
S201 execute face recognition
S202 has face portion been found
S203 face processing confirmation screen displayed
S204 is face processing performed
S205 select face processing method
S206 execute selected processing
S207 is face processing operation completed
S300 select parallel scroll mode
S301a acquire unprocessed image
S301b acquire processed image
S302 synthesize images, display synthesized image
S303 has joystick been operated
S304 has scrolling operation been performed
S305a move unprocessed image according to amount of operation
S305b move processed image according to amount of operation
S306 execute retaining routine
S401 paste message to processed image data (image 1)
S402 paste message to unprocessed image data (image 2)
S403 counter “i” reset to 0
S404 display image 1
S405 have two seconds elapsed
S406 display image 2
S407 have two seconds elapsed
S408 counter “i” incremented by 1
S409 determine whether “i” has reached 3
S501 acquire unprocessed/processed image data
S502 is there image designated to be retained
S503 record shooting date in both sets of image data
S504 impart “retain” flag to image designated to be retained
S505 impart “interim storage” flag to image designated to be unretained
S506 execute before/after selection routine
S601 display before/after selection screen
S602 has “before” been selected
S603 record unprocessed data
S604 has “after” been selected
S605 store processed image data into memory
S606 delete selection screen
S607 has “edit image” been selected
S608 proceed to “edit image mode”
S701 is image data stored
S702 is “interim storage flag” stored
S703 has D time elapsed since shooting date
S704 display on-screen message
S705 has deletion of image data been instructed
S706 delete image data
S707 specify retaining of image data, execute retaining routine

1. An image data processing apparatus comprising:
a capturing unit for capturing image data;
a processing unit for processing the image data;
a display unit for displaying unprocessed image data and processed image data;
a user operation unit;
a changing unit for changing a display state of the image data displayed on the display unit in accordance with operation of the user operation unit, wherein
the display unit displays the unprocessed image data and the processed image data side by side; and
the changing unit synchronously changes a display state of a remaining set of image data upon changing of a display state of one set of image data of the unprocessed image data and the processed image data, which are displayed side by side.

2. The image data processing apparatus according to claim 1, wherein changing of the display state corresponds to a scrolling operation; and
the changing unit simultaneously scrolls the unprocessed image data and the processed image data in such a way that corresponding portions of the unprocessed image data and the processed image data are displayed on the display unit.

3. The image data processing apparatus according to claim 1, wherein
changing of the display state corresponds to scale-up or scale-down; and
the changing unit simultaneously scales up or down, at single magnifying power, the unprocessed image data and the processed image data in such a way that corresponding portions of the unprocessed image data and the processed image data are displayed on the display unit.

4. The image data processing apparatus according to claim 1, wherein
changing of the display state corresponds to rotation; and
the changing unit displays the unprocessed image data and the processed image data on the display unit while concurrently rotating the unprocessed image data and the processed image data in a single rotating direction and through a single rotation angle

5. An image data processing apparatus comprising:
a capturing unit for capturing image data;
a processing unit for processing the image data; and
a display unit for displaying unprocessed image data and processed image data, wherein
the display unit alternately displays the unprocessed image data and the processed image data in time sequence.

6. The image data processing apparatus according either claim 1 or 5, further comprising:
a synthesizing unit for synthesizing at least either one of specifics data showing specifics of processing of the processing unit and area data showing a processed area with at least any one of unprocessed image data and processed image data, and displaying the synthesized image data.

7. The image data processing apparatus according claim 6, wherein the processed area includes a face portion or an eye portion of a subject.

8. The image data processing apparatus according claim 6, wherein the specifics of processing include correction of red eyes of a subject.

9. The image data processing apparatus according claim 6, wherein the specifics of processing include processing for recognizing a face of a subject.

10. The image data processing apparatus according claim 6, wherein the synthesizing unit displays the specifics data and the area data in a synthesized manner when a difference between image information about unprocessed image data and information about processed image data is a predetermined threshold value or more.

11. The image data processing apparatus according claim 6, wherein the synthesizing unit displays area data pertaining to an area where a difference between information about unprocessed image data and processed image data becomes a maximum, or displays specifics data pertaining to the area in a synthesized manner.

12. The image data processing apparatus according to any one of claims 1 through 11, further comprising:
a storage unit for storing either the unprocessed image data or the processed image data.

13. The image data processing apparatus according claim 12, further comprising:
a selecting unit for selecting image data to be stored in the storage unit.

14. The image data processing apparatus according claim 13, further comprising:
a deleting unit for deleting the image data which have not been selected by the selecting unit.

15. The image data processing apparatus according claim 13, further comprising a unit for temporarily storing, into the storage unit, the image data which have not been selected by the selecting unit, for a given period of time.

16. An image data processing method using a computer, the computer comprising:
a capturing step of capturing image data;
a processing step of processing the image data; and
a displaying step of displaying unprocessed image data and processed image data on a display unit, wherein
the unprocessed image data and the processed image data are displayed side by side on the display unit; and,
when a processor of a computer changes a display state of image data displayed on the display unit in accordance with an operation of a user operation unit,
a display state of one set of image data of the unprocessed image data and the processed image data, which are displayed side by side, is altered, and a display state of a remaining set of image data is also altered synchronously.

17. An image data processing method using a computer, the computer comprising:
a capturing step of capturing image data;
a processing step of processing the image data; and
a display step of displaying unprocessed image data and processed image data, wherein
a processor of the computer alternately displays in time sequence on a display unit the unprocessed image data and the processed image data.

18. The image data processing method according to claim 16 or 17, wherein the processor synthesizes at least either one of specifics data showing specifics of processing and area data showing a processed area with at least either one of unprocessed image data and processed image data, and displays the synthesized image data on the display unit.
